(19) United States
(12) Patent Application Publication
(10) Pub. No.: US 2004/0259521 A1
(43) Pub. Date: Dec. 23, 2004

(54) Maintenance and administration method of broadcasting system

(76) Inventor: Soon-Koo Cho, Seoul (KR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,270

(22) PCT Filed: Sep. 8, 2002
(86) PCT No.: PCT/KR02/01520

(30) Foreign Application Priority Data
Aug. 10, 2001 (KR) 2001-48154

(51) Int. Cl. H04M 3/00

(52) U.S. Cl. 455/404.1; 455/418

(57) ABSTRACT

Disclosed is a broadcasting system management method for use in a plurality of broadcasting systems in diverse locations, wherein the method includes the steps of: checking the status of the broadcasting systems at a server networked with a plurality of broadcasting systems; and notifying the results of the check to an expert manager.

### TECHNICAL FIELD

The present invention relates to a broadcasting system, and more specifically, to a broadcasting system management method.

### BACKGROUND ART

In general, large buildings under the Fire Services Act are required to have a broadcasting system in case of emergencies, eg. accident rescue. The broadcasting system can prove to be invaluable when it comes to saving people's lives or rescuing/evacuating people from various situations. Therefore, it is quite important to keep the broadcasting system well managed.

As the broadcasting system becomes more advanced and complicated, more experienced and professional technicians are required to manage the system. However, it is not always easy to hire and train individuals for such positives. As such, a more efficient method for managing the broadcasting system is needed.

Besides the purposes discussed above, i.e. evacuating and rescuing people from emergencies or disasters, the broadcasting system is also used for internal broadcasting in a company. The internal broadcasting services are mostly provided by an individual broadcasting operator, who may do voice broadcasting, may broadcast sky wave broadcasting programs, or may play an audio recorder, by individually operating the broadcasting system. However, this type of broadcasting is extremely inconvenient in many respects.

A proposed solution to the above problem is to use an audio recorder where pre-produced programs are recorded and played. However, this can not adapt to diverse broadcasting patterns needed in buildings. In other words, companies, restaurants, cafeterias, shopping malls, or complex buildings use different broadcasting patterns. Therefore, manufacturing an audio recorder that is suitable for all kinds of broadcasting patterns is extremely difficult. Accordingly, it is desirable to develop a new broadcasting service method, capable of providing appropriate broadcasting programs to suit everyone's needs.

In short, it is desirable to develop a new broadcasting service method, which is capable of managing a conventional broadcasting system more efficiently and professionally, while providing high quality broadcasting services that can adapt to diverse environments with more convenience and ease.

### DISCLOSURE OF INVENTION

It is an object of the present invention to provide a broadcasting system management method, which is capable of managing broadcasting systems more efficiently and professionally, while providing the highest quality broadcasting services adaptive to diverse applications (i.e. usage environments).

To achieve the above object, a broadcasting system management method includes the steps of: checking the state of the broadcasting systems at a server networked with a plurality of broadcasting systems; and notifying the results of the check to an expert manager.

### BRIEF DESCRIPTION OF DRAWINGS

The above objects, features and advantages of the present invention will become more apparent from the following detailed description when taken in conjunction with the accompanying drawings, in which:

FIG. 1 is a schematic diagram of a broadcasting system in accordance with a preferred embodiment of the present invention;

FIG. 2 is a block diagram of the broadcasting system in accordance with the preferred embodiment of the present invention;

FIG. 3 is a flow chart illustrating a channel formation method in accordance with the preferred embodiment of the present invention;

FIG. 4 is a flow chart illustrating different kinds of services provided by a host in accordance with the preferred embodiment of the present invention;

FIG. 5 diagrammatically discloses an application window for membership in accordance with the preferred embodiment of the present invention;

FIG. 6 is a flow chart illustrating a method for creating a broadcasting schedule in accordance with the preferred embodiment of the present invention;

FIG. 7 diagrammatically discloses a browser window in accordance with the preferred embodiment of the present invention;

FIG. 8 is a flow chart illustrating how to manage content in accordance with the preferred embodiment of the present invention;

FIG. 9 exemplifies well organized content in accordance with the preferred embodiment of the present invention; and

FIGS. 10 and 11 are flow charts illustrating a method for administering clients in accordance with the preferred embodiment of the present invention.

### BEST MODE FOR CARRYING OUT THE INVENTION

A preferred embodiment of the present invention will now be described with reference to the accompanying drawings.

The present invention enables a host at a remote place to manage or control a plurality of broadcasting systems established in diverse places, whereby a small number of specialized managers can manage the multiple broadcasting systems collectively. In addition, the host is in charge of administering each broadcasting system for helping the specialized managers of the host to be able to operate the multiple broadcasting systems that can adapt to different environments.

In the present invention, the host is equipped with a variety of multimedia broadcasting content (hereinafter referred to as “content”), including audio and animation, and an appropriate broadcasting schedule that can adapt to different usage environments, which is created on the basis of the various content. In this way, a broadcasting system manager does not have to bother to operate the broadcasting system at every broadcast, yet can still provide the highest quality broadcasting services that can adapt to different environments by using the various content.

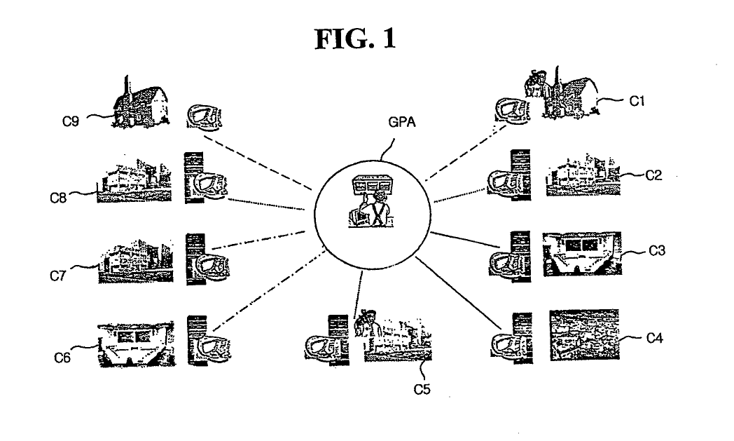

FIG. 1 discloses a schematic diagram of a broadcasting system according to the preferred embodiment of the present invention, wherein a host (GPA) and a plurality of clients C1 through C9 are networked together over a commercial network like the Internet or other dedicated type networks. The host (GPA) has a variety of content, and provides content to each client in accordance with a pre-designated broadcasting schedule for clients C1 through C9, respectively. Moreover, the host (GPA) checks the status of clients C1 through C9 periodically or on special events, thereby managing clients C1 through C9. The special event mentioned above can be the receipt of accident detection information.

Further, the host (GPA), under the control of a specialized (or professional) manager, performs the duties of turning power on/off for clients C1 through C9, rebooting, and adding/deleting operational commands or software, thereby managing clients C1 through C9 under various conditions.

Clients C1 through C9 each create a broadcasting schedule based on the various content provided for by the host (GPA). The host(GPA) then broadcasts the content responsive to the schedule. Also, in case of emergencies, accidents or when the connection between clients and host is interrupted, clients C1 through C9 save the content responsive to the broadcasting schedules and information on alarm broadcasting. Hence, if sudden accidents are detected, the clients can still transmit the information on accident detection to the host (GPA).

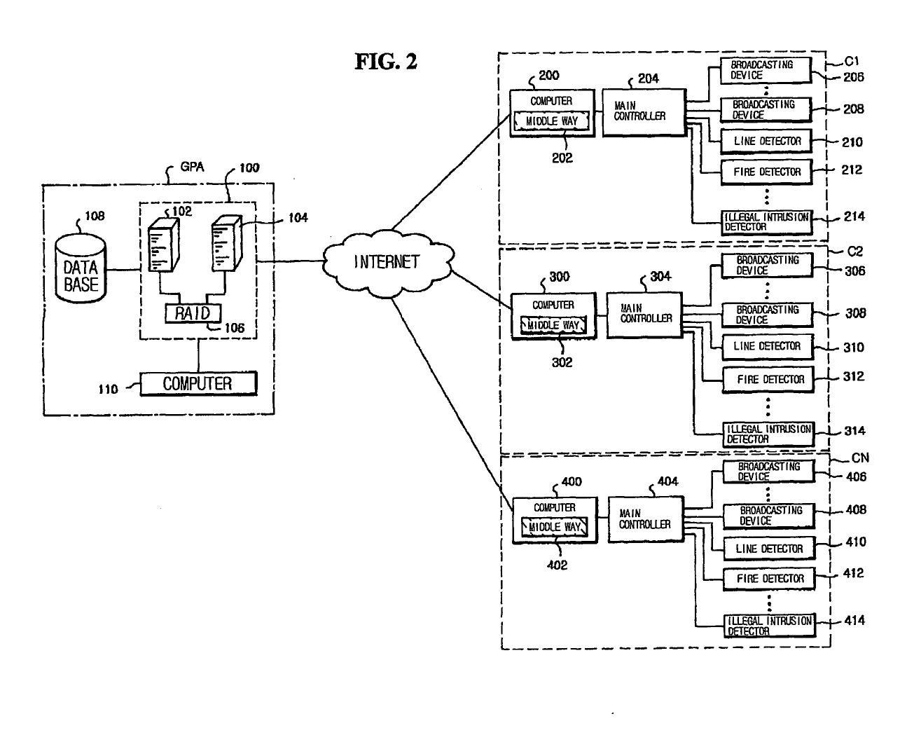

The configuration of the system discussed above will be described in greater detail below with reference to FIG. 2.

The host (GPA) has a server 100, which includes double servers 102, 104 and a raid 106 that is used as storage for the double servers 102, 104. According to the preferred embodiment of the present invention, the server 100 manages and administers clients C1 through CN, and provides broadcasting services at the request of each client C1 through CN, and provides alarm service responsive to accident detection. Database 108 stores all kinds of information, i.e. information on membership, various content, broadcasting schedules for individual clients, information on broadcasts originating from multiple locations (or information on multi no space organizational broadcast programs), group information among clients, and GPA software. The GPA software is used for administering clients under the control of server 100 and providing broadcasting services. The GPA software is installed in the clients' computers 200, 300, and 400, respectively. Computer 110 of the host (GPA) interfaces between server 100 and specialized managers for better administration and management over clients C1 through CN.

Every client C1 through CN has a plurality of broadcasting devices 206 through 208, 306 through 308, and 406 through 408 for providing broadcasts following a broadcasting schedule. The broadcasting devices include a speaker, RDRP, and a displayer. Each computer 200, 300, and 400 mounted in respect to clients C1 through CN has access to server 100 of the host (GPA) over a network, thereby interfacing between main controllers 204, 304, and 404. In addition, computers 200, 300 and 400 interface between non-specialized (non-professional) manager and server 100. In other words, non-specialized manager has access to server 100 through computers 200, 300, and 400, whereby a broadcasting schedule based on various content provided can be created, GPA software can be downloaded, multiple broadcasts can be set up, a group with other clients can be formed, or additional services can be requested. Further, computers 200, 300, and 400 reserve content responsive to broadcasting schedules and information on alarm broadcasting. Therefore, even when the connection with server 100 is cut off, the broadcasting services are not interrupted. Moreover, computers 200, 300, and 400 are mounted with middle wares 202, 302, and 402, which is software responsible for buffering and acting as a gateway to a number of diverse broadcasting systems.

Main controllers 204, 304, and 404 mounted in each client C1 through CN control broadcasting devices 206 through 208, 306 through 308, and 406 through 408, according to the content based on broadcasting schedules provided by the host (GPA), thereby providing broadcasting services. Also, main controllers 204, 304, and 404 receive accident detection information from accident detecting devices, namely line detectors 210, 310, and 410, fire detectors 212, 312, 412, and illegal intrusion detectors 214, 314, and 414, and provide the information to computers 200, 300, and 400. Further, main controller 204, 304, and 404 provide broadcasting services based on content provided by computers 200, 300, and 400 or information on alarm broadcasting.

Line detectors 210, 310, and 410 detect, whether the lines are short or open, and then send the detection result to computers 200, 300, and 400 through main controllers 204, 304, and 404. Fire detectors 212, 312, and 412, as it says, detects fire by employing a commonly used fire detector. The fire detector sends the detection results to computers 200, 300, and 400 through main controllers 204, 304, and 404. Lastly, illegal intrusion detectors 214, 314, and 414 detect any motion by using an infrared sensor, and send the detection result to computers 200, 300, and 400 through main controllers 204, 304, and 404.

Preferably, broadcasting services of the present invention are implemented by providing streaming (formatted) content to clients who access to the host (GPA). The streaming format looks like Table 1 below:

TABLE 1

| | | | |
|---|---|---|---|
| Header | Client | Command | Broadcasting information |

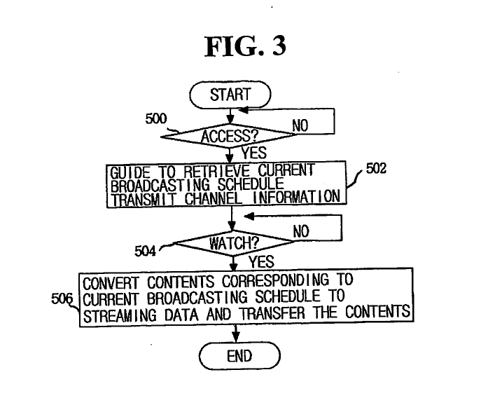

As shown in Table 1, the streaming format consists of a header, client identification information, commands, and broadcasting information, whereby corresponding content is provided to a selected client. Such streaming content is provided, through a channel connected to computer 200, to one of clients C1 who accesses server 100. The channel formation procedure will be explained below with reference to FIG. 3.

Channel access between server 100 and client C1 is based on URL (Uniform Resource Locator). Server 100 provides channel information necessary for channel formation to computer 200 belonging to client C1. If a number of clients are in a group, a fixed port is allocated to the group. Computer 200 manages channels responsive to channel information. Particularly, the present invention uses URL of C-class network. Available IP (Internet Protocol) addresses of C-class network total 254, and given that the subnetwork is configured, more than 200 URLs could be used. Server 100 provides multiple content to many clients according to the aforementioned channel.

When client C1 makes access (S500), server 100 retrieves a current broadcasting schedule of the corresponding client C1, informs the schedule to the client, and transmits channel information on content responsive to the broadcasting schedule (S502). As a non-specialized or non-expert manager of client C1 requests broadcasting services according to the current broadcasting schedule (S504), server 100 allows client C1 to make access to a corresponding channel to the channel information, and converts the content responsive to the current broadcasting schedule to the streaming format through the channel to thus provide them to client C1 (S506). Transmissions of the channel information and channel formation processes are carried out between computer 200 and server 100, although they are not displayed on the screen. Thus, the non-specialized manager can focus on his work without being involved in the channel formation process.

FIG. 3 illustrates the channel formation steps involved in unified broadcasting. If client C1 wants multiple broadcasting, server 100 permits the client to make additional access to other content besides the basic channel, thereby implementing multiple broadcasting.

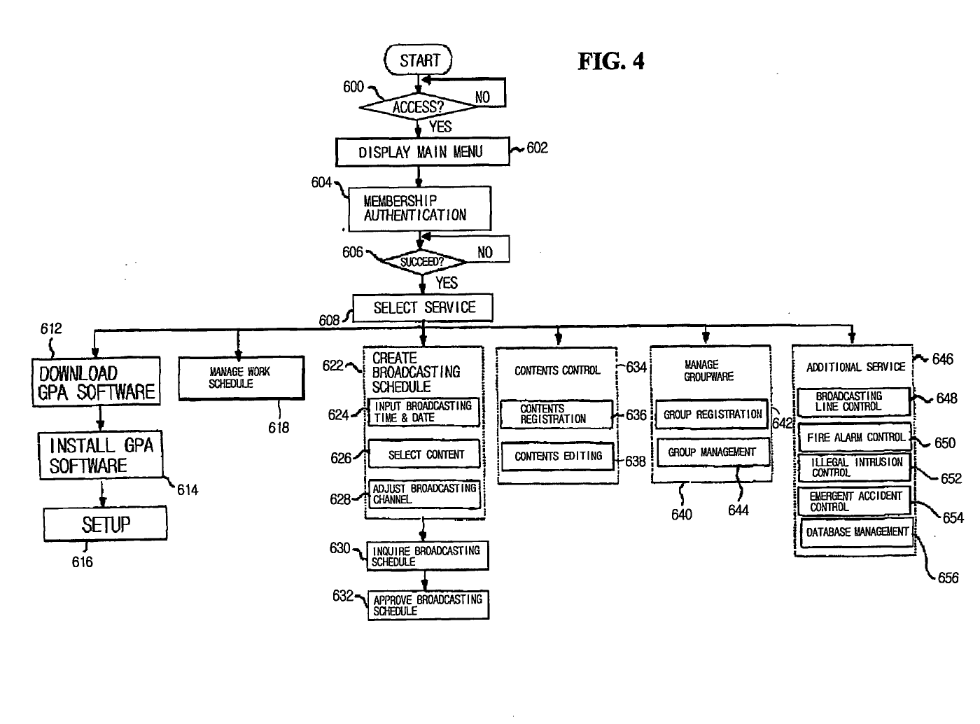

FIG. 4 discloses services provided by the host (GPA).

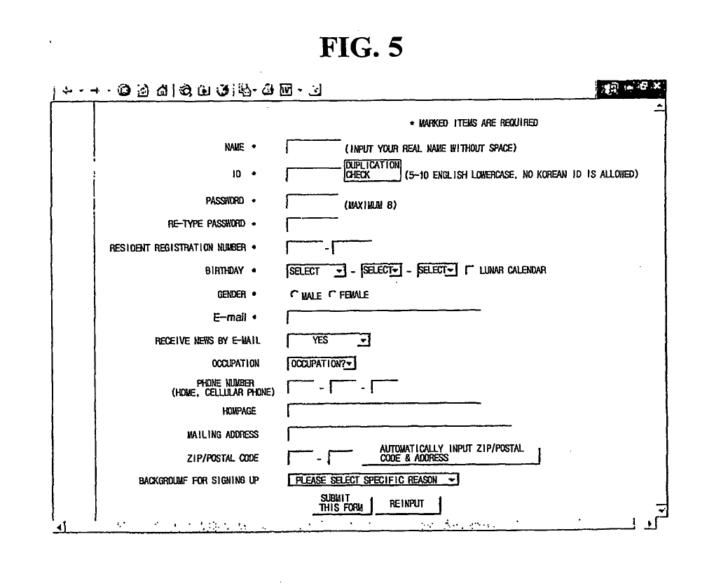

When the non-specialized manager of client C1 makes access through computer 200, server 100 presents a main menu (S602). The main menu consists of a step-by-step guide to download GPA software, manage work schedules, manage broadcasting schedules, and manage content and groupware. The main menu also provides a guide to download additional services and membership login. The non-specialized manager of client C1 should register as a member to get diverse services provided by server 100. FIG. 5 illustrates a membership registration window. As shown in the drawing, the non-specialized manager can apply for membership by inputting personal information, i.e. name, ID, password, etc. Upon completing the registration, the non-specialized manager of client C1 can log in via membership authentication procedure (S604, 606).

Later, the non-specialized manager of client C1 selects one of the services displayed on the main menu, and requests server 100 to provide a desired service. For instance, if the manager requests ‘software download service’, server 100, in response to the request, downloads and sets up GPA software to client's (C1) computer 200 (S612, 614, and 616). As such, GPA software is downloaded and installed in client's (C1) computer 200 automatically. When the installation takes place, processes in connection with an input/output channel and main controller 204 are interfaced and checked. In addition, a plurality of broadcasting devices 206, 208, and a plurality of accident detectors 210 through 214 are automatically performed. If there are any problems, a proper action is also guided to take care of the problem. Such a setup can be readjusted if necessary or if the client's (C1) hardware is changed. In addition, GPA software is generally provided when the client's (C1) hardware is set up.

Further, server 100 optionally provides work schedule management service (S618).

If the non-specialized manager requests a broadcasting schedule management service, server 100 retrieves information necessary for editing a broadcasting schedule, e.g. broadcasting time and date, broadcasting content and broadcasting channel control (or adjustment) information from client C1. Based on the information, a broadcasting schedule (S622, 624, 626, and 628) is created, and an inquiry service regarding the created broadcasting schedule to the manager as requested (S630) is provided. If the non-specialized manager of client 1 (C1) approves the created broadcasting schedule, the content is broadcasted in accordance with the corresponding broadcasting schedule (S632).

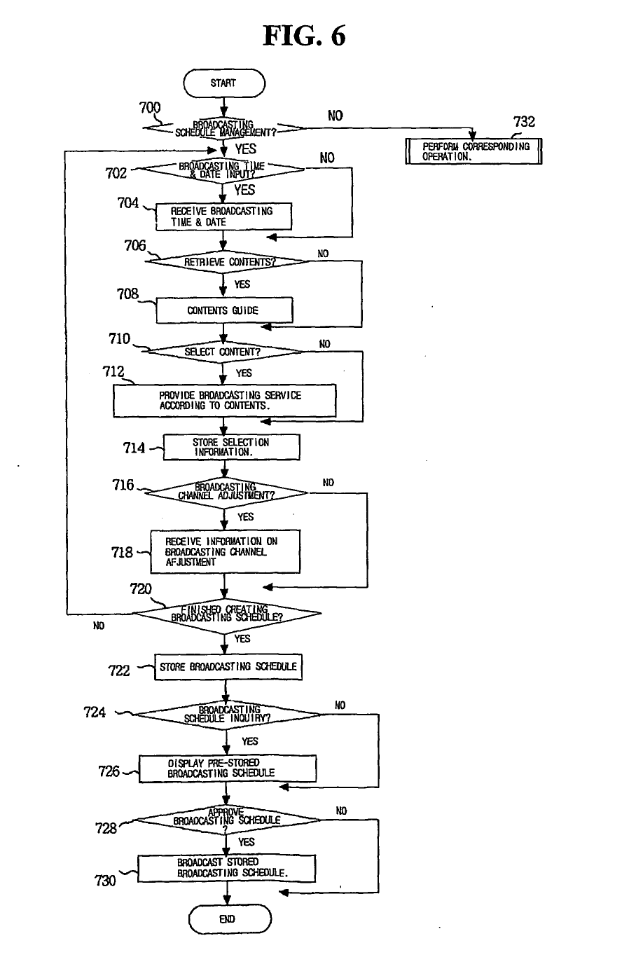

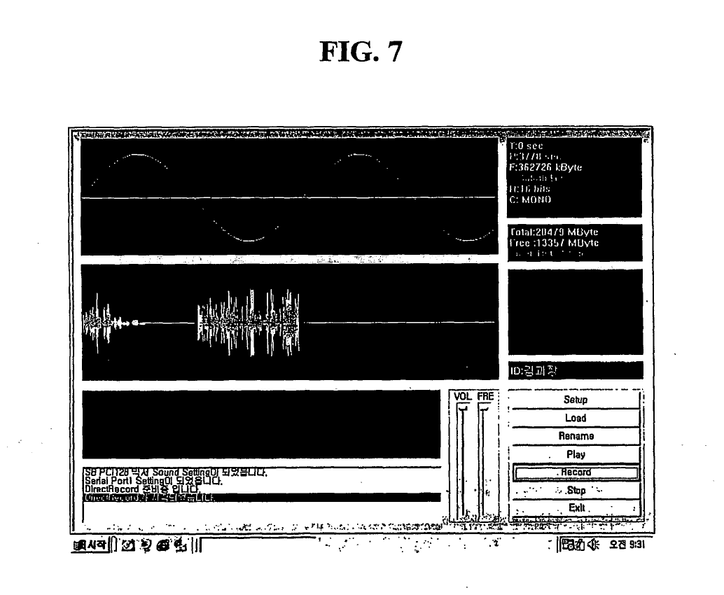

The broadcasting schedule management procedure will be described in greater detail with reference to FIG. 6. When the non-specialized manager of client (C1) drives GPA software, computer 200, as depicted in FIG. 7, drives a broadcasting service browser. If the non-specialized manager requests the broadcasting schedule management service through the broadcasting service browser, computer 200 temporarily stores the broadcasting time and date that are inputted (S700 through 704). When the manager requests content retrieval service (S706), computer 200 requests server 100 of the host (GPA) to provide a list of registered content. In response to the request, server 100 provides the list of content to computer 200. Then, computer 200 displays the content on the basis of the list of registered content (S708). When the non-specialized manager selects the type of content (S710), computer 200 provides server 100 of the host (GPA) with the selected information. Server 100 provides broadcasting information on the selected content to computer 200, whereby the manager can check the broadcasting service relevant to the broadcasting information (S712) in advance. Also, if the non-specialized manager requests broadcasting channel adjustment service, computer 200 receives information necessary for broadcasting channel adjustment and provides the information to server 100 of the host (GPA) (S716, 718). In short, by repeating the aforementioned processes, i.e. inputting broadcasting time/date, selecting broadcasting contents, and adjusting broadcasting channels, the non-specialized manager can create a long-term broadcasting schedule. Upon the completion of the broadcasting schedule (S720), server 100 stores the broadcasting schedule in database 108 (S722).

Server 100 displays the temporarily stored broadcasting schedule at an inquiry request of the non-specialized manager through computer 200 (S714, S726). The inquiry request can be made by clicking a button on the broadcasting service browser window. On the other hand, the broadcasting schedule inquiry can be set up in such manner that it is automatically sent to a pre-registered email address.

When the non-specialized manager approves the corresponding broadcasting schedule through computer 200, server 100 provides broadcasting services conforming to the corresponding broadcasting schedule.

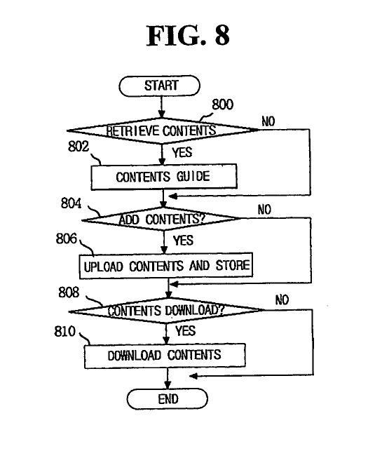

Moreover, when client C1 requests content management service, server 100 provides content registration and editing services (S634, S636). More details on this process are now provided below with reference to FIG. 8.

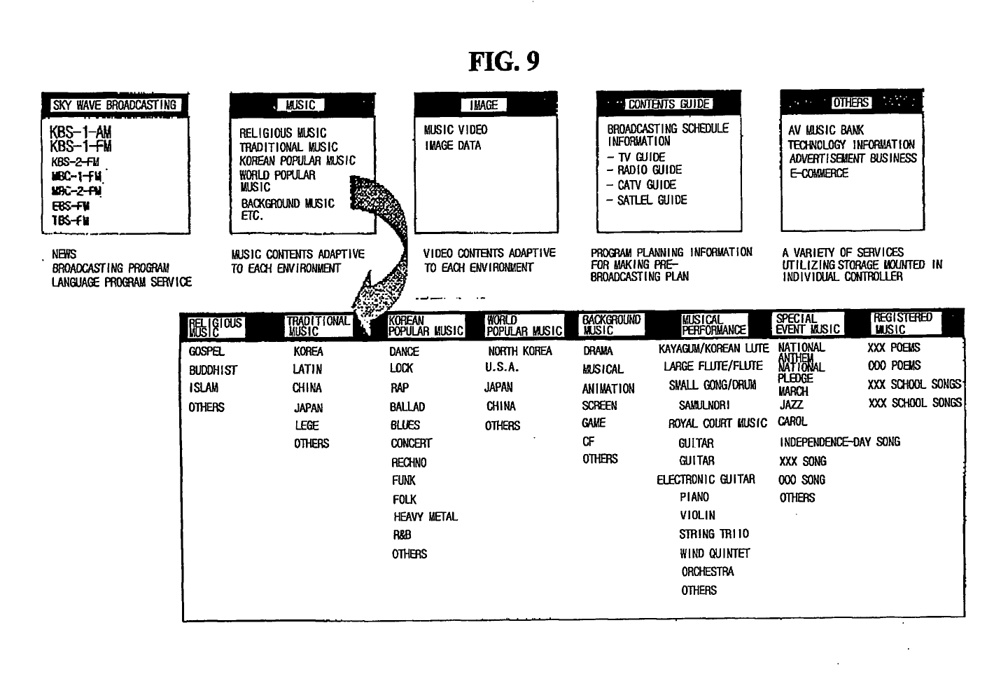

When the non-specialized manager requests content retrieval service (S800), computer 200 requests server 100 of the host (GPA) to provide a list of registered content, and server 100, in response to the request, provides the list of content to computer 200. Then, computer 200 displays content on the basis of the list of registered content (S802). Now referring to FIG. 9 illustrating one example of the registered content, the host (GPA) consists of basic sky wave broadcastings, pre-registered content, music content adaptive to user environment, image content, and other types of content. The basic slcy wave broadcasting content include KBS-1FM content and KBS-2 FM content: music content includes religious and traditional music; image content includes music videos and image content. Actually, such content is pre-registered by the expert (specialized) manager of the host (GPA) and the non-specialized manager of client C1. That is, the expert manager can pre-register diverse content adaptive to a variety of usage environments; and the non-specialized manager can pre-register particular content for his own use, e.g. school songs, poems, or music written by the non-specialized manager.

When the non-specialized manager requests to add more content through computer 200, server 100 uploads corresponding content from computer 200 and stores it in database 102 (S806).

When the non-specialized manager of client C1 wants to download content according to the broadcasting schedule or information on alarm broadcasting to computer 200 to use in case of emergencies (S800), server 100 does as requested. That is, it downloads the content conforming to the broadcasting schedule provided by a corresponding client C1 and the information on alarm broadcasting to computer 200 (S810). Computer 200 then stores the downloaded content or information. Although the present embodiment only illustrates downloading content or information on alarm broadcasting at the request of the non-specialized manager, the content or information on alarm broadcasting can be downloaded every time the broadcasting schedule is updated or at prefixed regular intervals.

Meanwhile, if the non-specialized manager of client C1 requests groupware management service, server 100 provides group registration and group management services (S640, S642, and S644). In other words, server 100 organizes a plurality of clients into one group, and manages or administers the clients in a group unit.

Server 100 also provides other additional services at the request of the non-specialized manager of client C1. More specifically, server 100 provides broadcasting line control, fire alarm control, illegal intrusion control, emergency accident control, and database control services (S646, 648, 650, 652, 654, and 656).

To explain more about the broadcasting line management, line detector 210 of client C1 inputs 20 KHz of test tone in the amplifier. The amplifier generates different outputs for different line states. For instance, if amplifier outputs excessively, line detector 210 concludes that the line is shortened. If the amplifier does not have any output, line detector 210 concludes that the line is cut off. This detection result is sent to computer 200 through main controller 204.

Upon receiving emergency accident detection information from line detector 210, fire detector 212, and illegal intrusion detector 214, computer 200 sends the information to server 100, and reads emergency broadcasting information out of storage, thereby broadcasting an emergency broadcasting program through main controller 204. In fact, if there is an emergency, main controller 204 is capable of broadcasting the emergency broadcasting program independently, with or without being connected to computer 200. To this end, main controller 204 usually stores the emergency broadcasting program.

When server 200 receives information in connection with emergency accident detection, it immediately notifies the incident to pre-registered contacts, depending on what kind of accident occurred. For example, fire station, police station, or particular person(s) are included in the list of contacts.

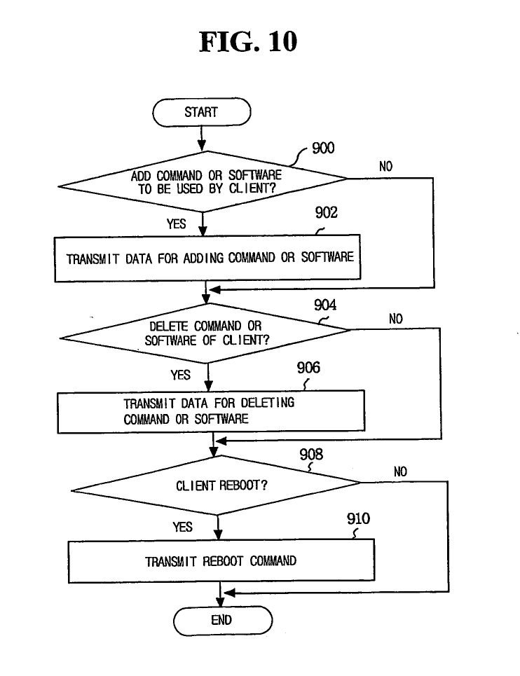

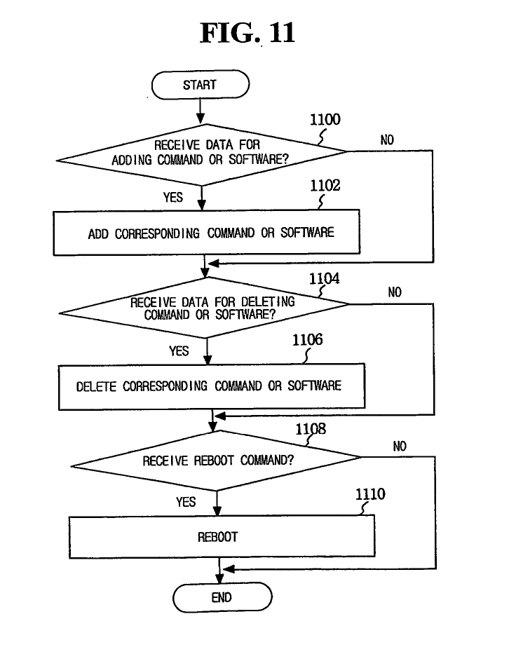

In FIGS. 10 and 11, a client C1 administration method is explained according to the preferred embodiment of the present invention. As shown in the drawings, the expert manager performs several processes, e.g. adding/deleting command or program, rebooting, and turning power on/off, upon a plurality of clients C1 through CN, whereby the manager can appropriately manage clients C1 through CN. In other words, the manager can improve client performance simply by placing necessary commands or programs for usage environment for each client. As such, the expert manager can place clients in a variety of systems through server 100. The following description will explain more about all of the aforementioned operations that are carried out by the expert manager.

First of all, when the expert manager of server 100 requests to add a command or program to be used in client C1, server 100 transmits data necessary for adding the command or program to client C1 (S900, S902). Also, when the expert manager of server 100 requests to delete a command or program out of client C1, server 100 transmits data necessary for deleting the command or program to client C1 (S904, S906). Further, when the expert manager of server 100 requests to reboot client C1, server 100 transmits a reboot command to client C1 (S908, S910).

If server 100 provides data for adding a command or program, clients C1 computer 200 loads the command or program in computer 200 responsive to the received data (S1100, S1102). In the meantime, if server 100 provides data for deleting a command or program, client's C1 computer deletes the corresponding command or program responsive to the received data (Si104, S1106). Lastly, if server 100 provides a reboot command, client's C1 computer reboots as commanded (S1108, S1110).

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

The present invention can be advantageously used for managing a plurality of broadcasting systems in different locations by a host at a remote place, whereby a small number of expert managers can manage the multiple broadcasting systems collectively.

Also, the present invention can improve the broadcasting systems' performance by enabling the host to administer the multiple broadcasting systems to be adaptive to different usage environments.

The present invention is very advantageous in that it can provide broadcasts adaptive to different usage environments very simply and conveniently by having the host equipped with diverse content in order to create broadcasting schedules appropriate for different purposes of corresponding buildings, thereby providing broadcasting services automatically whenever necessary.

1. A broadcasting system management method for use in a plurality of broadcasting systems in diverse locations, the method comprising the steps of:
checking the status of the broadcasting systems at a server networked with a plurality of broadcasting systems;
notifying results of the check to an expert manager; and
notifying the state of emergency or accident to pre-designated contacts, depending on the type of emergency or accident, once the server confirms that one of the plurality of broadcasting systems indicates that an emergency or accident has occurred.

2. The method as defined in claim 1, wherein the server checks the plurality of broadcasting systems periodically or on special events.

3. The method as defined in claim 1, further comprising the step of providing an alarm service, once the server confirms that one of the plurality of broadcasting systems indicates that an emergency or accident has occurred.

4. The method as defined in claim 3, wherein the emergency or accident is one of a fire, line problem, or illegal intrusion.

5. The method as defined in claim 1, further comprising the steps of:
if an expert manager requests to add or delete a command or software of one of the broadcasting systems through the server, transmitting data for adding or deleting a corresponding command or software; and
adding or deleting the command or software according to the data provided to the broadcasting system.

6. The method as defined in claim 1, further comprising the steps of:
if an expert manager requests to control power of one of the broadcasting systems through the server, transmitting a power control command to a corresponding broadcasting system; and
performing a power control process at the broadcasting system to conform to the command. broadcasting system.

7. The method as defined in claim 1, further comprising the steps of:
if an expert manager requests to control power of one of the broadcasting systems through the server, transmitting a power control command to a corresponding broadcasting system; and
performing a power control process at the broadcasting system to conform to the command.
